(19) United States
(12) Patent Application Publication
(10) Pub. No.: US 2022/0056926 A1
(43) Pub. Date: Feb. 24, 2022

(54) RECOVERING WASTE OIL

(71) Applicant: Saudi Arabian Oil Company, Dhahran (SA)

(72) Inventors: Ali A. Al-Hamed, Al-Hofuf (SA); Mahmoud A. Abdulmohsen, Al-Ahsa (SA); Hesham Dhafer Al-Zaher, Udhailiyah (SA); Abdulaziz A. Almulhim, Al-Hofuf (SA); Mohammed A. Almuhainy, Al-Hofuf (SA)

(21) Appl. No.: 17/001,378

(22) Filed: Aug. 24, 2020

(51) Int. Cl. F04F 5/46; B01F 5/04; F04F 5/22

(52) U.S. Cl. CPC F04F 5/463; F04F 5/22; B01F 5/0428; F04F 5/467

(57) ABSTRACT

A convergent nozzle is in a flow path from a liquid inlet of the ejector and a liquid outlet of the ejector. A convergent end of the convergent nozzle has a smaller cross-sectional area than an inlet of the convergent nozzle. The convergent nozzle is sized to increase a velocity of the liquid to supersonic velocities and decrease a pressure of the liquid. A low pressure housing includes a low pressure inlet into an interior of the low pressure housing. A convergent-divergent nozzle includes a mixed liquid inlet in fluid communication to receive fluid from the convergent nozzle and the low pressure housing.

### TECHNICAL FIELD

This disclosure relates to recovering waste oil, oily water, or both, in a processing facility.

### BACKGROUND

When processing hydrocarbons, oil, gas and water are separated from one another through a variety of processes, such as static separation and chemical demulsification. During processing, oil and oily water are produced from these processes. Additional separation occurs in an effort to recover the oil and oily water from drainage pits and to move the recovered oil, typically by pump, back into the main process stream for further processing to recover the oil from the oily water.

### SUMMARY

This disclosure describes technologies relating to recovering waste oil in processing facilities.

An example implementation of the subject matter within this disclosure is a single-phase ejector with the following features. A convergent nozzle is in a flow path from a liquid inlet of the ejector and a liquid outlet of the ejector. A convergent end of the convergent nozzle has a smaller cross-sectional area than an inlet of the convergent nozzle. The convergent nozzle is sized to increase a velocity of the liquid to supersonic velocities and decrease a pressure of the liquid. A low pressure housing includes a low pressure inlet into an interior of the low pressure housing. A convergent-divergent nozzle includes a mixed liquid inlet in fluid communication to receive fluid from the convergent nozzle and the low pressure housing.

Some aspects of the example single-phase injector, that can be combined with the single-phase ejector alone or in part, include the following. The low pressure housing is fluidically connected to a sump pit.

Some aspects of the example single-phase injector, that can be combined with the single-phase ejector alone or in part, include the following. The inlet of the single-phase ejector is fluidically connected to a discharge of an oil pump.

Some aspects of the example single-phase injector, that can be combined with the single-phase ejector alone or in part, include the following. The convergent nozzle and the convergent-divergent nozzle include an erosion resistant coating.

Some aspects of the example single-phase injector, that can be combined with the single-phase ejector alone or in part, include the following. The single-phase ejector is located in a recycle line.

Some aspects of the example single-phase injector, that can be combined with the single-phase ejector alone or in part, include the following. A pressure ratio across convergent nozzle is substantially between 30:1 and 35:1.

Some aspects of the example single-phase injector, that can be combined with the single-phase ejector alone or in part, include the following. A pressure at the outlet of the ejector is greater than a pressure within the low pressure housing and less than a pressure at the ejector inlet.

An example implementation of the subject matter within this disclosure is a method with the following features. A first, single-phase liquid flow has a velocity increased and a pressure decreased by a convergent nozzle to form a low pressure, high velocity jet exiting the convergent nozzle. The velocity is greater than a sonic velocity of the single-phase liquid. A second, single-phase liquid flow, is received into a low pressure housing in response to the decreased pressure of the low pressure, high velocity jet, downstream of the convergent nozzle. The first single-phase liquid and the second single-phase liquid are mixed within the low pressure housing to form a mixed single-phase liquid. The mixed single-phase liquid is received by a convergent-divergent nozzle. A normal shockwave is produced within a throat of the convergent-divergent nozzle. The mixed single-phase liquid is flowed at a sub-sonic velocity downstream of the throat of the convergent-divergent nozzle responsive to the normal shockwave.

Some aspects of the example method, that can be combined with example method alone or in part, include the following. The mixed single-phase liquid is directed to a downstream conditioning system.

Some aspects of the example method, that can be combined with example method alone or in part, include the following. A flashing pressure of the first, single-phase liquid flow is less than the low pressure produced by the convergent nozzle.

Some aspects of the example method, that can be combined with example method alone or in part, include the following. The pressure within the low pressure housing is greater than or equal to ambient pressure.

Some aspects of the example method, that can be combined with example method alone or in part, include the following. A pressure at an outlet of the convergent-divergent nozzle is greater than the low pressure and less than the high pressure.

Some aspects of the example method, that can be combined with example method alone or in part, include the following. A flashing pressure of the second, single-phase liquid is less than the lower pressure produced by the convergent nozzle.

An example implementation of the subject matter within this disclosure is a system with the following features. An ejector defines an inlet fluidically coupled to an outlet of an oil pump. The ejector includes a convergent nozzle in a flow path from a liquid inlet of the ejector and the outlet of the ejector. A convergent end of the convergent nozzle has a smaller cross-sectional area than an inlet of the convergent nozzle. The convergent nozzle is sized to increase a velocity of the liquid to supersonic velocities and decrease a pressure of the liquid. A low pressure housing includes a low pressure inlet into an interior of the low pressure housing. A convergent-divergent nozzle includes a mixed liquid inlet in fluid communication to receive liquid from the convergent nozzle and the low pressure housing.

Some aspects of the example system, that can be combined with example system alone or in part, include the following. The low pressure housing is fluidically connected to an oil accumulation pit.

Some aspects of the example system, that can be combined with example system alone or in part, include the following. The convergent nozzle and the convergent-divergent nozzle comprise an erosion resistant material.

Some aspects of the example system, that can be combined with example system alone or in part, include the following. The outlet of the ejector is fluidically connected to direct the liquid to conditioning equipment.

Some aspects of the example system, that can be combined with example system alone or in part, include the following. A ratio of cross-sectional areas of the inlet to a convergent end of the convergent nozzle is substantially 35:1.

Some aspects of the example system, that can be combined with example system alone or in part, include the following. A pressure at the outlet of the ejector is greater than a pressure within the low pressure housing and less than a pressure at the ejector inlet.

Some aspects of the example system, that can be combined with example system alone or in part, include the following. The single-phase ejector is located in a recycle line of the oil pump.

Particular implementations of the subject matter described in this disclosure can be implemented so as to realize one or more of the following advantages. The invention reduces downtime of recovery systems and drainage pits by eliminating rotating equipment and replacing it with static equipment. In addition, the subject matter described herein improves safety practices for pits and sumps a the processing facilities can have may safety and hazard issues with such systems due to rotating equipment failures that are being potentially as a source of ignition.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example waste oil recover system.

FIG. 2 is a schematic diagram of an example ejector that can be used with the example waste oil recovery system.

FIG. 3 is a flowchart of an example method that can be used with aspects of this disclosure.

Like reference numbers and designations in the various drawings indicate like elements.

### DETAILED DESCRIPTION

During hydrocarbon production, liquid collected from process equipment drains and pump oil seepage runs through a closed or open drain system into a sump pit. The sump pit has pumps that are used to pump the liquid out of the pit when the liquid level becomes high through fluid conduits, such as pipes or hoses, which connect the centrifugal pumps discharge header to the oil-accumulation pit. The intent of having an oil-accumulation pit is to accommodate the drained oil and oily water from the open and closed drain systems and strip the accumulated oil, oily-water, or both, from the sump pit thru its pumps. When the level within the oil-accumulation pit gets too high, the oil in the pit floats on top of the water, and the water will settle down due to gravity separation. In addition, there are oil recovery pumps that bring the waste oil and oily-water back into the processing facility for processing and conditioning.

This disclosure relates to using static equipment, such as a single-phase ejector, to recover drained oil, oily-water, or both, from sump and accumulation-oil pits or similar process vessels by using internally generated energy at the facility as a motive source (high-pressure flow). This disclosure describes a single-phase ejector with a main flow path tied to processing pumps, for example, export oil pumps, and a low-pressure input being tied to sump and accumulation-oil pits. It should be noted that all fluid flows are substantially liquid (greater than 90% by volume) within this system, making the system single phase. A high pressure flow, once it passes through the ejector, will experience a significant pressure decrease, resulting in a sonic velocity at the neck and supersonic velocity at the exit. This will create a low-pressure area that can stimulate the flow from a separate source, such as the sump and oil-accumulation pits. After that, this high velocity flow, along with the oil/oily-water from the pits, will pass through a converging-diverging nozzle which will cause velocity drop and pressure increase to recover the drained oil/oily-water. Then, the mixture will be sent to the various conditioning systems within the processing plant.

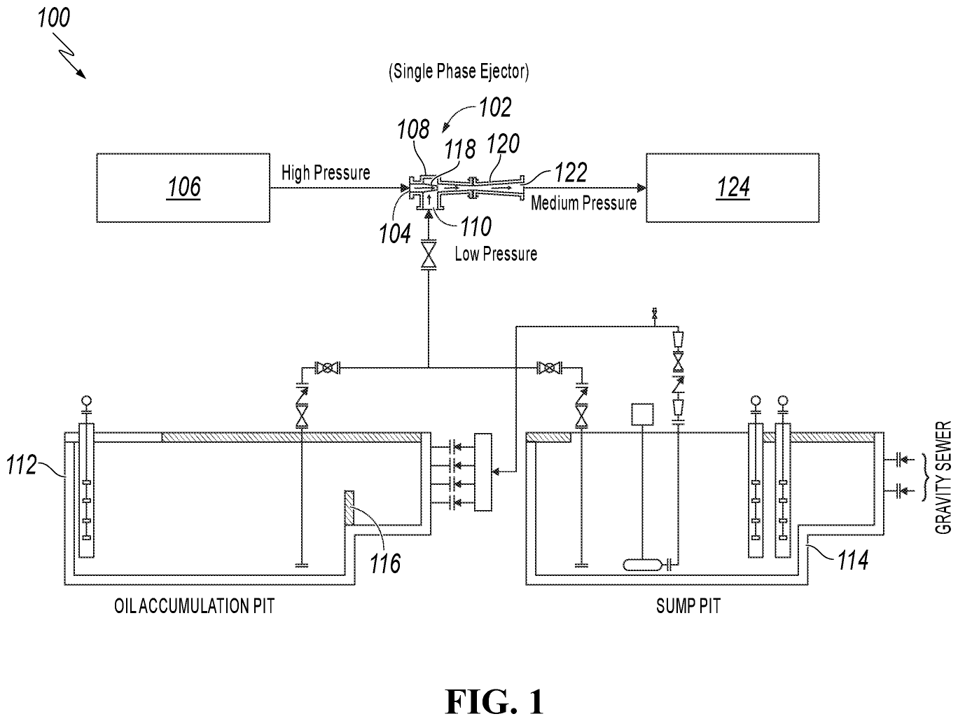

FIG. 1 is a schematic diagram of an example waste oil recovery system 100. The waste oil recovery system 100 includes an ejector 102 defining an injector inlet 104 fluidically connected to a discharge of a pump 106, for example, an oil pump. The oil pump 106 can include a booster pump, export pump, or any other oil pump within an oil production/processing system that is pumping substantially dead oil. Dead oil is oil that has had lighter end hydrocarbons, which can flash at lower pressures, removed from the oil. As such, the liquid entering the ejector is a single phase. In some implementations, the ejector 102 can be included within a recycle line of the oil pump 106.

The ejector includes a low pressure housing 108 defining a low pressure inlet 110 into an interior of the low pressure housing 108. In some implementations, the low pressure housing 108 is fluidically connected to an oil accumulation pit 112. The oil accumulation pit 112 receives waste oil from a production facility, for example, from a closed drain system, an open drain system, or from a sump pit 114. In some implementations, the oil accumulation pit 112 can include a weir 116 to separate oil from water and other liquids by gravity separation. Despite oil in the oil accumulation pit 112 being waste oil, it can often be salvaged and further refined into usable products. Typically, a pump with a low required net positive suction head is used to move the oil from the accumulation pit into a process stream. Such pumps typically have a short minimum time between failures as they can easily be run dry. The systems described herein utilize an ejector 102 to move fluid from the oil accumulation pit into a process stream, thus eliminating the need for such pumps.

In some implementations, the low pressure housing 108 is fluidically connected to a sump pit 114. The sump pit 114 receives waste oil and water from a production facility, for example, from a closed drain system or an open drain system. In some implementations, the low pressure housing is fluidically connected to both the oil accumulation pit 112 and the sump pit 114. In such implementations, control valves can control which source is directed to the low pressure housing, and in some implementations, the control valves can also throttle a flowrate from each flow source. Regardless of what fluid source the low pressure housing 108 is fluidically connected to, the pressure at the fluid source is greater than the pressure within the low pressure housing 108, creating a fluid flow from the fluid source to the low pressure housing 108. The single phase liquid passing through the convergent nozzle 118 is mixed with the liquid from the oil accumulation pit 112, sump pit 114, or both, within the low pressure housing 108 and the downstream convergent-divergent nozzle 120 to form a mixed single phase flow.

During operations, a pressure at the outlet 122 of the ejector is greater than a pressure within the low pressure housing 108 and less than a pressure at the ejector inlet 104. The outlet 122 of the ejector 102 is fluidically connected to direct liquid flowing through the ejector toward conditioning equipment 124. Such conditioning equipment 124 can include pumps, heaters, coolers, separators, drums, traps, or chemical reaction towers (for example, glycol or amine units).

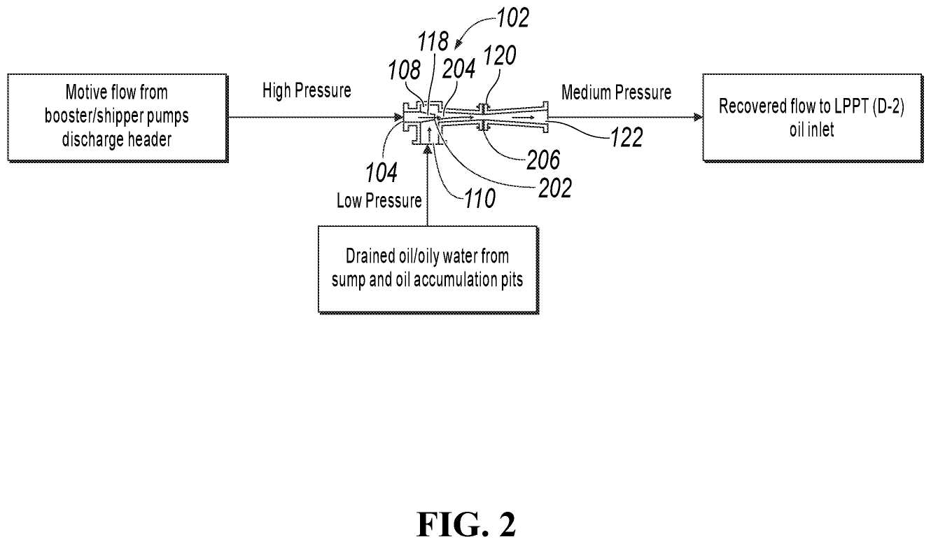

FIG. 2 is a schematic diagram of an example ejector 102 that can be used with the example waste oil recovery system. The ejector 102 includes a convergent nozzle 118 in a flow path from an ejector inlet 104 of the ejector 102 and an outlet 122 of the ejector 102. A convergent end 202 of the convergent nozzle 118 has a smaller cross-sectional area than an ejector inlet 104 of the convergent nozzle 118. The convergent nozzle 118 is sized to increase a velocity of the liquid to sonic or supersonic velocities while a pressure of the liquid is decreased. In some implementations, a pressure ratio across the convergent nozzle is substantially between 30:1 and 35:1. In some implementations, a ratio of cross-sectional areas of the inlet to a convergent end of the convergent nozzle is substantially 35:1. In order to achieve such high velocities, namely sonic or supersonic velocities, a normal shock wave can be formed near the convergent end 202 of the convergent nozzle 118 to allow for the supersonic transition. The convergent end 202 of the convergent nozzle 118 is located within the low pressure housing 108. Within the low pressure housing 108, a low pressure liquid, such as liquid from the sump pit 114, oil accumulation pit 112, or both, is introduced to the high velocity stream. The low pressure liquid is mixed with the high velocity stream within both the low pressure housing 108 and the downstream convergent-divergent nozzle 120. As both the high velocity stream and the low pressure stream are liquids, and the pressure within the low-pressure housing remains greater than the flashing pressure of either the high velocity stream or the low pressure stream, the two streams mix to form a mixed, single phase stream of liquid.

The downstream convergent-divergent nozzle 120 is located downstream of the convergent nozzle 118 and the low pressure housing 108. The downstream convergent-divergent nozzle 120 defines a mixed liquid inlet 204 in fluid communication to receive fluid from the convergent nozzle 118 and the low pressure housing 108. The downstream convergent-divergent nozzle 120 is configured to reduce the velocity of the mixed, single phase stream to subsonic velocities, and to mix the high velocity stream and the low pressure stream. As such, during steady state operations, a normal shockwave is produced near a throat 206 of the downstream convergent-divergent nozzle 120 to reduce the velocity of the mixed, single phase stream. The velocity of the stream is reduced sufficiently to lower the risk of impingement erosion on downstream piping and acoustic vibrations that can be inherent with high velocity flows. In some implementations, the convergent nozzle 118, the downstream convergent-divergent nozzle 120, or both, include an erosion resistant coating or base material to mitigate erosion caused by high velocity fluids, particulates, or both. In some implementations, the pressure drop across the entire ejector 102 is substantially 35 to 50 pounds per square inch.

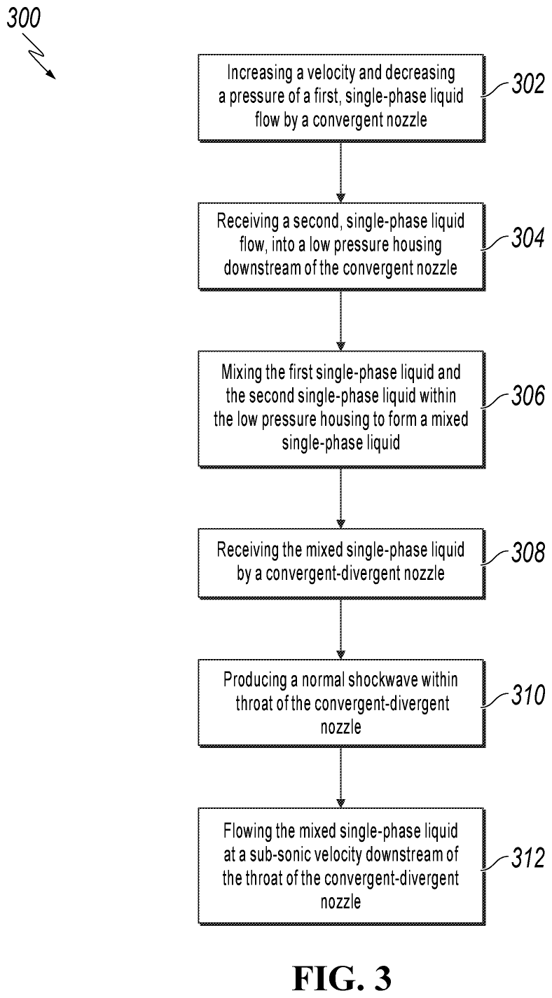

FIG. 3 is a flowchart of an example method 300 that can be used with aspects of this disclosure. At 302, a velocity and a pressure of a first, single-phase liquid flow is increased and decreased, respectively, by a convergent nozzle to form a low pressure, high velocity jet exiting the convergent nozzle. The velocity is increased to be greater than a sonic velocity of the single-phase liquid. A flashing pressure of the first, single-phase liquid flow is less than the low pressure produced by the convergent nozzle. In some implementations, the pressure within the low pressure housing is greater than or equal to ambient pressure.

At 304, a second, single-phase liquid flow is received into a low pressure housing in response to the decreased pressure of the low pressure, high velocity jet, downstream of the convergent nozzle. A flashing pressure of the second, single-phase liquid is less than the lower pressure produced by the convergent nozzle.

At 306, the first single-phase liquid and the second single-phase liquid are mixed within the low pressure housing to form a mixed single-phase liquid. At 308, the mixed single-phase liquid is received by a convergent-divergent nozzle. At 310, a normal shockwave is produced within a throat of the convergent-divergent nozzle. At 312, the mixed single-phase liquid is flowed at a sub-sonic velocity downstream of the throat of the convergent-divergent nozzle responsive to the normal shockwave.

Downstream of the convergent-divergent nozzle, the mixed single-phase liquid is directed to a downstream conditioning system. In general, the pressure at an outlet of the convergent-divergent nozzle is greater than the low pressure within the low-pressure chamber or housing and less than the high pressure at the inlet of the ejector.

While this disclosure contains many specific implementation details, these should not be construed as limitations on the scope of what may be claimed, but rather as descriptions of features specific to particular implementations. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described components and systems can generally be integrated together in a single product or packaged into multiple products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A single-phase ejector comprising:
a convergent nozzle in a flow path from a liquid inlet of the ejector and a liquid outlet of the ejector, a convergent end of the convergent nozzle having a smaller cross-sectional area than an inlet of the convergent nozzle, the convergent nozzle being sized to increase a velocity of the liquid to supersonic velocities and decrease a pressure of the liquid;
a low pressure housing comprising a low pressure inlet into an interior of the low pressure housing; and
a convergent-divergent nozzle comprising a mixed liquid inlet in fluid communication to receive fluid from the convergent nozzle and the low pressure housing.

2. The single-phase ejector of claim 1, wherein the low pressure housing is fluidically connected to a sump pit.

3. The single-phase ejector of claim 1, wherein the inlet of the single-phase ejector is fluidically connected to a discharge of an oil pump.

4. The single-phase ejector of claim 1, wherein the convergent nozzle and the convergent-divergent nozzle comprise an erosion resistant coating.

5. The single-phase ejector of claim 1, wherein the single-phase ejector is located in a recycle line.

6. The single-phase ejector of claim 1, wherein a pressure ratio across convergent nozzle is substantially between 30:1 and 35:1.

7. The single-phase ejector of claim 1, wherein a pressure at the outlet of the ejector is greater than a pressure within the low pressure housing and less than a pressure at the ejector inlet.

8. A method comprising:
increasing a velocity and decreasing a pressure of a first, single-phase liquid flow by a convergent nozzle to form a low pressure, high velocity jet exiting the convergent nozzle, the velocity being greater than a sonic velocity of the single-phase liquid;
receiving a second, single-phase liquid flow, into a low pressure housing in response to the decreased pressure of the low pressure, high velocity jet, downstream of the convergent nozzle;
mixing the first single-phase liquid and the second single-phase liquid within the low pressure housing to form a mixed single-phase liquid;
receiving the mixed single-phase liquid by a convergent-divergent nozzle;
producing a normal shockwave within a throat of the convergent-divergent nozzle; and
flowing the mixed single-phase liquid at a sub-sonic velocity downstream of the throat of the convergent-divergent nozzle responsive to the normal shockwave.

9. The method of claim 8, further comprising directing the mixed single-phase liquid to a downstream conditioning system.

10. The method of claim 8, wherein a flashing pressure of the first, single-phase liquid flow is less than the low pressure produced by the convergent nozzle.

11. The method of claim 8, wherein the pressure within the low pressure housing is greater than or equal to ambient pressure.

12. The method of claim 8, wherein a pressure at an outlet of the convergent-divergent nozzle is greater than the low pressure and less than the high pressure.

13. The method of claim 8, wherein a flashing pressure of the second, single-phase liquid is less than the lower pressure produced by the convergent nozzle.

14. A system comprising:
an oil pump; and
an ejector defining an inlet fluidically coupled to an outlet of the oil pump, the ejector comprising:
a convergent nozzle in a flow path from a liquid inlet of the ejector and the outlet of the ejector, a convergent end of the convergent nozzle having a smaller cross-sectional area than an inlet of the convergent nozzle, the convergent nozzle being sized to increase a velocity of the liquid to supersonic velocities and decrease a pressure of the liquid;
a low pressure housing comprising a low pressure inlet into an interior of the low pressure housing; and
a convergent-divergent nozzle comprising a mixed liquid inlet in fluid communication to receive liquid from the convergent nozzle and the low pressure housing.

15. The system of claim 14, wherein the low pressure housing is fluidically connected to an oil accumulation pit.

16. The system of claim 14, wherein the convergent nozzle and the convergent-divergent nozzle comprise an erosion resistant material.

17. The system of claim 14, wherein the outlet of the ejector is fluidically connected to direct the liquid to conditioning equipment.

18. The system of claim 14, wherein a ratio of cross-sectional areas of the inlet to a convergent end of the convergent nozzle is substantially 35:1.

19. The system of claim 14, wherein a pressure at the outlet of the ejector is greater than a pressure within the low pressure housing and less than a pressure at the ejector inlet.

20. The system of claim 14, wherein the single-phase ejector is located in a recycle line of the oil pump.
